(19) United States
(12) Patent Application Publication
(10) Pub. No.: US 2013/0135774 A1
(43) Pub. Date: May 30, 2013

(54) LIGHT-EMITTING DIODE DRIVING CIRCUIT HAVING SHORT CIRCUIT PROTECTION

(71) Applicant: Fei Li, Shenzhen (CN)

(72) Inventor: Fei Li, Shenzhen (CN)

(73) Assignee: SHENZHEN CHINA STAR OPTOELECTRONICS TECHNOLOGY CO., LTD., Shenzhen (CN)

(21) Appl. No.: 13/379,888

(22) PCT Filed: Dec. 1, 2011
(86) PCT No.: PCT/CN11/83322

§ 371 Date: Dec. 21, 2011

(30) Foreign Application Priority Data
Nov. 29, 2011 (CN) 20110386800.8

(51) Int. Cl. H02H 9/00

(52) U.S. Cl. 361/18

(57) ABSTRACT

The present invention discloses a light-emitting diode driving circuit having short circuit protection. The light-emitting diode driving circuit has a boost circuit, a first switch unit, a light-emitting diode string and a control chip. The boost circuit receives an input voltage and outputs a relatively higher output voltage. The first switch unit is connected between the boost circuit and the light-emitting diode string. The control chip is connected to the boost circuit and the first switch unit, and controls the first switch unit to be cut off when the light-emitting diode string is short-circuited, so as to cut off the current loop from the input power source to the light-emitting diode string to achieve the object of short-circuit protection and stopping power consumption.

### FIELD OF THE INVENTION

The present invention relates to photo-lithography technologies, and more particularly to a light-emitting diode driving circuit having short circuit protection that avoids unnecessary power consumption.

### BACKGROUND OF THE INVENTION

With reference to FIG. 1, FIG. 1 is a known circuit diagram of a light-emitting diode driving circuit used in a backlight module of a liquid crystal display device, which mainly includes a boost circuit 90, a driving chip 91 and a light-emitting diode string 92. The boost circuit 90 includes an inductor L1, a second transistor Q2 and a diode D5, and the light-emitting diode string 92 includes a plurality of light-emitting diodes D1 to D4.

An input power source Vin is transferred through the boost circuit 90, and then provide a sufficient voltage to drive the light-emitting diode string 92 to emit lights. The driving chip 91 can control the second transistor Q2 to switch on/off the boost circuit 90 and further to control the action of the light-emitting diode string 92. When one of the light-emitting diodes of the light-emitting diode string 92 is short-circuited, high electric current and high voltage may possibly damage circuit elements. Therefore, the driving chip 91 detects if any one of the light-emitting diodes thereof is short- circuited by connecting to a negative end of the light-emitting diode string 92. If an event of short circuit is occurred, the second transistor Q2 will be cut off to turn off the boost circuit 90 to achieve short circuit protection.

However, after turning off the boost circuit 90, although the input power source Vin is not boosted, it still consume electric energy through a grounded loop of the light-emitting diode string 92. Therefore, the light-emitting diode driving circuit still has safety concern and is unable to effectively save energy.

Hence, it is necessary to provide a light-emitting diode driving circuit having short circuit protection to overcome the problems existing in the conventional technology.

### SUMMARY OF THE INVENTION

A primary object of the invention is to provide a light-emitting diode driving circuit having short circuit protection to solve a problem that the conventional light-emitting diode driving circuits still have safety concern and are unable to effectively save energy.

To achieve the above object, the present invention provides a light-emitting diode driving circuit having short circuit protection comprising:

a boost circuit receiving an input voltage to output a relatively higher output voltage;

a first switch unit connected to the boost circuit;

a light-emitting diode string connected to the first switch unit and receiving the output voltage to be driven to emit light when the switch unit is conducted; and

a control chip connected to the boost circuit and the first switch unit and cutting off the first switch unit when a short circuit occurred to the light-emitting diode string.

In one embodiment of the present invention, the boost circuit includes:

a first inductor connected to the input voltage;

a diode connected to the first inductor with an anode thereof;

a capacitor having a first end connected to a cathode of the diode and having a second end connected to the control chip; and

a second switch unit having a first end connected between the first inductor, a second end connected to ground and a third end connected to the control chip, and switching on/off the conduction between the first end and the second end of the second switch according to a control signal of the control chip.

In one embodiment of the present invention, the second switch unit is a power transistor, the first end thereof is a drain, the second end thereof is a source and the third end thereof is a gate.

In one embodiment of the present invention, the first switch unit is a power transistor, a drain thereof is connected to the boost circuit via a first resistor, a source thereof is connected to the light-emitting diode string and a gate thereof is connected to the control chip; the control chip is connected to two ends of the first resistor and determines if the light-emitting diode string is short-circuited by detecting whether the voltage value at a bottom end of the first resistor is zero volt; when the voltage value at the bottom end of the first resistor is zero volt, the control chip cuts off the first switch unit.

In one embodiment of the present invention, the first switch unit is a power transistor, a drain thereof is connected to the boost circuit via a first resistor, a source thereof is connected to the light-emitting diode string, and a gate thereof is connected to the control chip and the second end of the capacitor; the control chip is connected to two ends of the first resistor and determines if the light-emitting diode string is short-circuited by detecting whether the voltage value at a bottom end of the first resistor is zero volt; when the voltage value at the bottom end of the first resistor is zero volt, the control chip cuts off the first switch unit and the second switch unit at the same time.

The present invention is mainly to connect a first switch unit to a boost circuit and a light-emitting diode string, and use a control chip to control the first switch unit to be cut off when the light-emitting diode string is short-circuited, so as to cut off the current loop from the input power source to the light-emitting diode string to achieve the object of short-circuit protection and stopping power consumption.

### DESCRIPTION OF THE DRAWINGS

FIG. 1 is a circuit diagram of a conventional light-emitting diode driving circuit; and

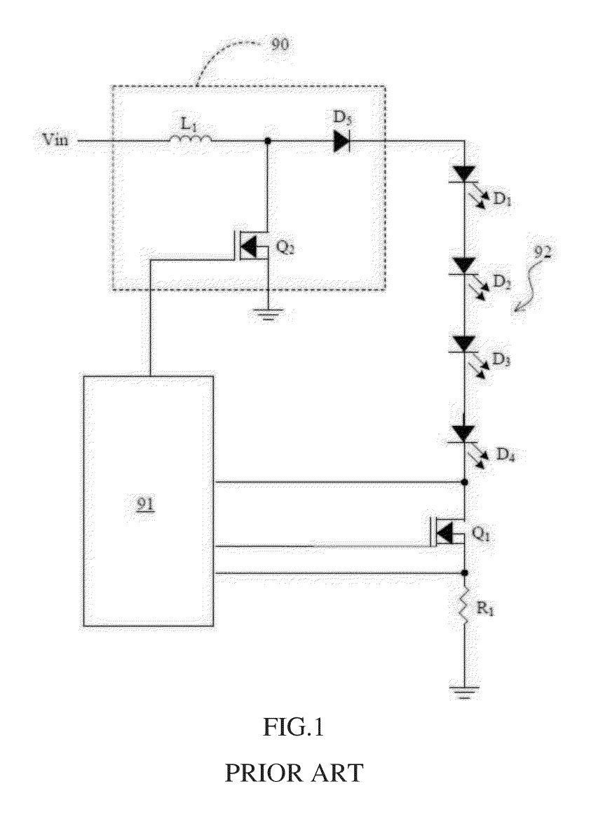

FIG. 2 is a circuit diagram of a preferred embodiment of a light-emitting diode driving circuit having short circuit protection in accordance with the present invention.

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

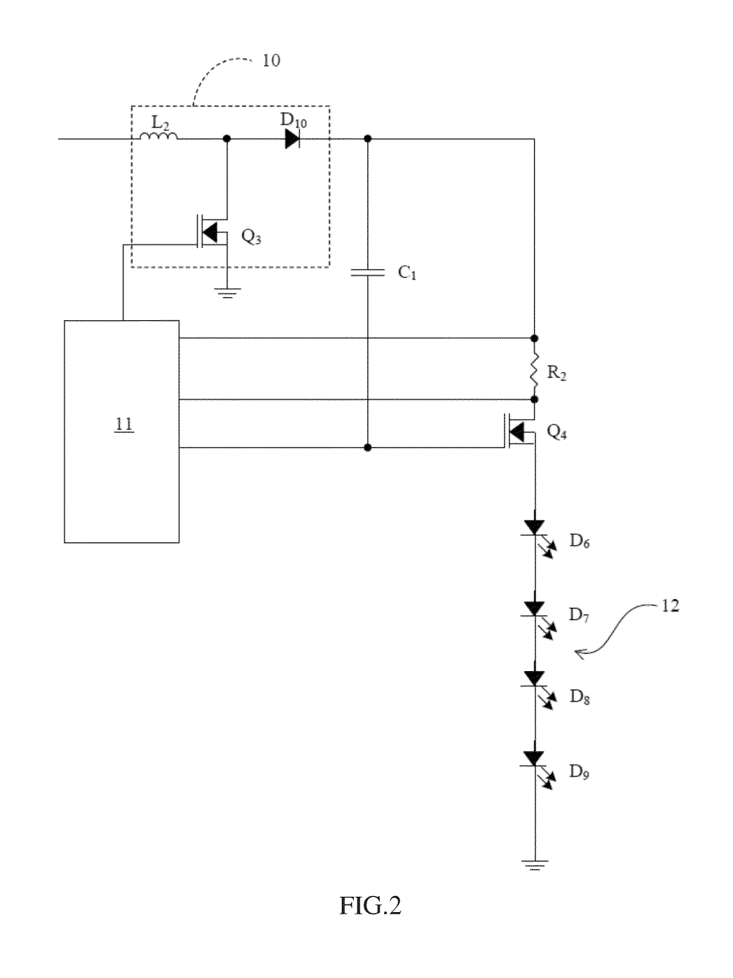

With reference to FIG. 2, FIG. 2 is a circuit diagram of a preferred embodiment of a light-emitting diode driving circuit having short circuit protection in accordance with the present invention. The light-emitting diode driving circuit having short circuit protection of the present invention mainly comprises a boost circuit 10, a first switch unit Q4, a light-emitting diode string 12 and a control chip 11.

The boost circuit 10 is connected to an input voltage Vin to output an output voltage which is relatively higher then the input voltage Vin. In the embodiment, the boost circuit 10 includes a first inductor L2, a diode D10, a capacitor C1 and a second switch unit Q3. The firs inductor L2 is connected to the input voltage. An anode of the diode D10 is connected to the first inductor L2. The capacitor C1 is connected to a cathode of the diode with a first end thereof, and is connected to the control chip 11 with a second end thereof. A first end of the second switch unit Q3 is connected between the first inductor and the anode of the diode, a second end thereof is connected to ground, a third end thereof is connected to the control chip 11, and switches on/off the conduction between the first end and the second end of the second switch unit Q3 according to a control signal of the control chip 11.

The foregoing second switch unit Q3 is preferably a power transistor, the first end thereof is a drain, the second end thereof is a source and the third end thereof is a gate. The control chip 11 may use a pulse-width modulation (PWM) technique to continuously switch on/off the second switch unit Q3 to achieve the object of boosting, wherein when the second switch unit Q3 is switched on, the diode D10 is reverse biased, and the electricity from the input voltage Vin is stored in the first inductor L2; when the second switch unit Q3 is switched off, the diode D10 is forward biased, the capacitor C1 receives the electric power from the input voltage Vin and the first conductor L2, therefore the output voltage can be higher than the input voltage Vin.

The first switch unit Q4 is connected to the boost circuit 10, in this embodiment, the first switch unit Q4 is a power transistor, a drain thereof is connected to the cathode of the diode D10 and the first end of the capacitor C1 of the boost circuit 10 via a first resistor R2; a source thereof is connected to the light-emitting diode string 12, and a gate thereof is connected to the control chip 11; the control chip 11 is connected to two ends of the first resistor R2.

The light-emitting diode string 12 is connected to the first switch unit Q4, and receives the output voltage to be driven to emit lights when the first switch unit Q4 is switched on; the light-emitting diode string 12 comprises a plurality of light-emitting diodes D6 to D9 connected in series.

The control chip 11 is used to cut off the first switch unit Q4 when the light-emitting diode string 12 is short-circuited. To be more detailed, when normally lighting, the control chip 11 uses the voltage difference on the first resistor R2 to compare with a constant current source inside the control chip 11 to achieve a constant current fort the light-emitting diode strip 12, in the meantime operation of the first switch unit Q4 is driven by the capacitor C1 that is connected to the gate of the first switch unit. When the light-emitting diode string 12 is short-circuited to ground, the voltage value at a bottom end of the first resistor R2 which the drain of the first switch unit Q4 is connected to is zero volt. Therefore, the control chip 11 can determine if the light-emitting diode string 12 is short-circuited by detecting whether the voltage value at the bottom end of the first resistor R2 is zero volt; when the voltage value at the bottom end of the first resistor R2 is zero volt, the control chip 11 cuts off the first switch unit Q4 to cut off the current loop from the input voltage Vin to the light-emitting diode string 12, and cuts off the second switch unit Q3 at the same time to turn off the boost circuit 10.

It is known from the above description, comparing with the conventional light-emitting diode driving circuit has a problem of safety concern and is unable to effectively save energy, the light-emitting diode driving circuit having short circuit protection connects a switch unit to a boost circuit and a light-emitting diode string, and use a control chip to control the switch unit to be cut off when the light-emitting diode string is short-circuited to ground, so as to cut off the current loop from the input power source to the light-emitting diode string, the voltage of the power source then is unable to be send out, and thereby accomplish short-circuit protection and achieve the object of eliminating safety concern and avoiding power consumption.

The present invention has been described with a preferred embodiment thereof and it is understood that many changes and modifications to the described embodiment can be carried out without departing from the scope and the spirit of the invention that is intended to be limited only by the appended claims.

1. A light-emitting diode driving circuit having short circuit protection, characterized in that: the light-emitting diode driving circuit having short circuit protection comprises:
a boost circuit receiving an input voltage to output a relatively higher output voltage;
a first switch unit connected to the boost circuit, wherein the first switch unit is a power transistor, and a drain thereof is connected to the boost circuit via a first resistor;
a light-emitting diode string connected to a source of the first switch unit and receiving the output voltage to be driven to emit lights when the switch unit is switched on; and
a control chip connected to the boost circuit and a gate of the first switch unit, and the control chip is connected to two ends of the first resistor and determines if the light-emitting diode string is short-circuited by detecting whether the voltage value at an bottom end of the first resistor is zero volt; when the voltage value at the bottom end of the first resistor is zero volt, the control chip cuts off the first switch unit and turns off the boost circuit.

2. A light-emitting diode driving circuit having short circuit protection, characterized in that: the light-emitting diode driving circuit having short circuit protection comprises:
a boost circuit receiving an input voltage to output a relatively higher output voltage;
a first switch unit connected to the boost circuit;
a light-emitting diode string connected to the first switch unit and receiving the output voltage to be driven to emit light when the switch unit is switched on; and
a control chip connected to the boost circuit and the first switch unit and cutting off the first switch unit when a short circuit occurred to the light-emitting diode string.

3. The light-emitting diode driving circuit having short circuit protection as claimed in claim 2, characterized in that: the boost circuit includes:
a first inductor connected to the input voltage;
a diode connected to the first inductor with an anode thereof;
a capacitor having a first end connected to a cathode of the diode and having a second end connected to the control chip; and
a second switch unit having a first end connected between the first inductor, a second end connected to ground and a third end connected to the control chip, and switching on/off the conduction between the first end and the second end of the second switch unit according to a control signal of the control chip.

4. The light-emitting diode driving circuit having short circuit protection as claimed in claim 3, characterized in that:
the second switch unit is a power transistor, the first end thereof is a drain, the second end thereof is a source and the third end thereof is a gate.

5. The light-emitting diode driving circuit having short circuit protection as claimed in claim 2, characterized in that:
the first switch unit is a power transistor, a drain thereof is connected to the boost circuit via a first resistor, a source thereof is connected to the light-emitting diode string and a gate thereof is connected to the control chip; the control chip is connected to two ends of the first resistor and determines if the light-emitting diode string is short-circuited by detecting whether the voltage value at a bottom end of the first resistor is zero volt; when the voltage value at the bottom end of the first resistor is zero volt, the control chip cuts off the first switch unit.

6. The light-emitting diode driving circuit having short circuit protection as claimed in claim 3, characterized in that:
the first switch unit is a power transistor, a drain thereof is connected to the boost circuit via a first resistor, a source thereof is connected to the light-emitting diode string, and a gate thereof is connected to the control chip and the second end of the capacitor; the control chip is connected to two ends of the first resistor and determines if the light-emitting diode string is short-circuited by detecting whether the voltage value at a bottom end of the first resistor is zero volt; when the voltage value at the bottom end of the first resistor is zero volt, the control chip cuts off the first switch unit and the second switch unit at the same time.
